(19) United States
(12) Patent Application Publication
(10) Pub. No.: US 2004/0059856 A1
(43) Pub. Date: Mar. 25, 2004

(54) Bus slot conversion module

(75) Inventors: Johni Chan, Rancho Santa Fe, CA (US); Luong Tan, San Diego, CA (US)

Correspondence Address: FITCH EVEN TABIN AND FLANNERY, 120 SOUTH LA SALLE STREET, SUITE 1600, CHICAGO, IL, 60603-3406, US

(73) Assignee: I-BUS Corporation, San Diego, CA

(21) Appl. No.: 10/065,205

(22) Filed: Sep. 25, 2002

(51) Int. Cl. G06F 13/00

(52) U.S. Cl. 710/301

(57) ABSTRACT

A bus slot conversion module including a canister for housing peripherals and coupling the peripherals to a bus slot of a computer backplane. The canister is designed to detachably mount within an available slot of a rack mounted chassis. The canister includes peripheral slots designed to couple with the peripherals and also includes a bus slot connecter designed to couple with a bus slot of a computer. Within the canister are electrical interconnects for connecting the peripheral slots having one type of pin configuration with the bus slot connector that has another type of pin configuration. In variations, the bus slot connector is a compact Peripheral Interconnect (PCI) connector and the peripheral slots are Single Connection Attachment (SCA) slots.

### BACKGROUND OF INVENTION

1. Field of the Invention

The present invention relates generally to computer system architecture, and more specifically to computer system bus architecture. Even more specifically, the present invention relates to communications between a computer system bus and peripheral devices.

2. Discussion of the Related Art

Computer system designs are typically structured so that a number of components are coupled directly or indirectly with a computer system's backplane. For example, microprocessors, random access memory (RAM) modules and BIOS ROM modules, and other components including printers, scanners, disk drives and optical drives (e.g., CD ROM dives and DVD Drives).

Typically expansion slots in the backplane provide an interface for peripherals to communicate with components coupled with the backplane. One system for organizing expansion slot communications between the backplane and peripherals is the Peripheral Component Interconnect (PCI) system. The PCI system is an interconnection system that supports both a newer PCI slot configuration, and in many designs, an older Industry Standard Architecture (ISA) slot configuration. Backplanes, however, are typically designed to include several PCI slots because the PCI system has a more modern and advantageous design, allowing, e.g., “plug and play” capability; thus, a PCI slot is often available for use.

Many peripherals, e.g., disk drives, and optical drives, however, are designed to couple with Integrated Drive Electronics (IDE) slots or Small Computer System Interface (SCSI) slots and cannot directly connect with PCI slots.

### SUMMARY OF INVENTION

In one embodiment, the invention can be characterized as a bus slot conversion module including a canister comprising a first frame bracket and a front panel wherein the first frame bracket is coupled with the front panel wherein the first frame bracket is configured to support a first peripheral, wherein the front panel is configured to couple with a front side of a chassis. The bus slot conversion module also includes a conversion portion comprising a first PCB board wherein the first PCB board is coupled to the first frame bracket and a first peripheral slot, the first PCB board comprising traces that interconnect the first peripheral slot and a bus slot connector coupled with the first PCB board. The first peripheral slot is configured to couple with the first peripheral, and the bus slot connector is configured to couple with a bus slot wherein the first peripheral slot comprises a different pin configuration than the bus slot. The bus slot is coupled with a backplane, and the backplane is within the chassis.

In another embodiment, the invention can be characterized as a method for using peripherals with an incompatible bus slot. The method including steps of inserting a first peripheral in a first peripheral dock of a canister wherein the first peripheral dock comprises a first frame bracket wherein the first peripheral is guided by the frame bracket and a front panel wherein the frame bracket is coupled with the front panel, coupling the first peripheral with a first peripheral slot coupled to a first PCB board wherein the first PCB board is coupled to the first frame bracket, wherein a bus slot connector is coupled to the PCB board wherein the first PCB board interconnects the first peripheral slot with the bus slot connector, placing the canister into a chassis wherein the chassis houses a backplane, and coupling the bus slot connector with a bus slot wherein the bus slot is coupled to the backplane, and wherein the first peripheral slot comprises a different pin configuration than the bus slot.

### BRIEF DESCRIPTION OF DRAWINGS

The above and other aspects, features and advantages of the present invention will be more apparent from the following more particular description thereof, presented in conjunction with the following drawings wherein:

FIG. 1 is a functional block diagram illustrating interaction between a bus slot conversion module and a computer backplane;

FIG. 2 is a schematic view of one embodiment of the bus slot conversion module of FIG. 1;

FIG. 3 is a flow chart describing the steps traversed by a user when implementing the bus slot conversion module of FIG. 2;

FIG. 4A and FIG. 4B are perspective views of one embodiment of the bus slot conversion modules of FIGS. 1 and 2;

FIG. 5 is a view taken along line A-A in FIG. 4A illustrating features of the first PCB board;

FIG. 6 is a view taken along line B-B in FIG. 4B illustrating features of the second PCB board;

FIG. 7 is a perspective view of the bus slot conversion module of FIG. 4B with the second PCB board removed;

FIG. 8 is a perspective view of the bus slot conversion module of FIG. 4A with the first PCB board removed;

FIG. 9 is a view of the bus slot conversion module of FIG. 7 with the first peripheral removed;

FIG. 10 is a view of the bus slot conversion module of FIG. 9 with the lower frame bracket removed;

FIG. 11 is a view of the bus slot conversion module of FIG. 9 with the second peripheral removed;

FIG. 12 is a rear view of the bus slot conversion module of FIG. 4A;

FIG. 13 is a rear view of the bus slot conversion module of FIG. 4A;

FIG. 14 is a rear view of first and second PCB boards of FIGS. 4 through 13 and one embodiment of interconnections there between; and

FIGS. 15A and 15B are perspective views of one embodiment of the rear transition module of FIG. 2.

Corresponding reference characters indicate corresponding components throughout the several views of the drawings.

### DETAILED DESCRIPTION

The following description is not to be taken in a limiting sense, but is made merely for the purpose of describing the general principles of the invention. The scope of the invention should be determined with reference to the claims.

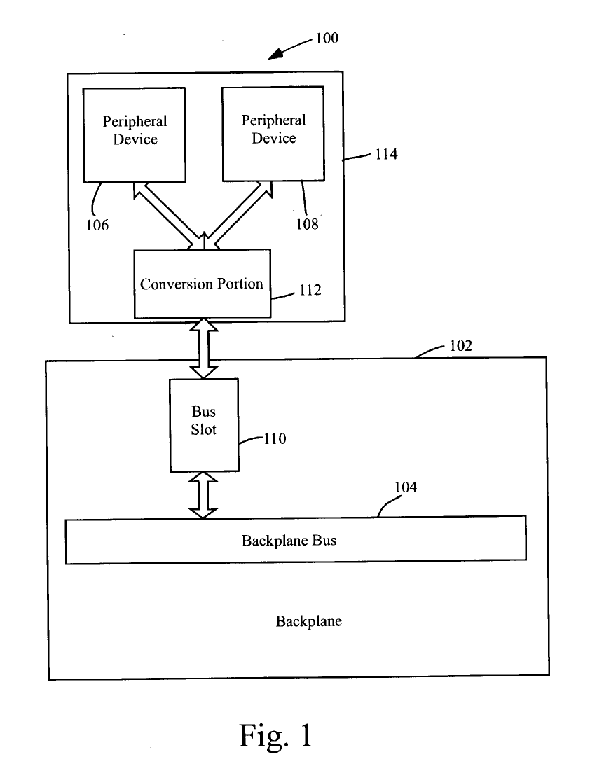

Referring first to FIG. 1, shown is a functional block diagram illustrating interaction between a bus slot conversion module 100 and a computer backplane 102. Shown are the bus slot conversion module 100, the computer backplane 102, a backplane bus 104, a first peripheral 106, a second peripheral 108, a bus slot 110, a conversion portion 112, and a canister 114.

The backplane 102 is shown coupled with the backplane bus 104, and the backplane bus 104 is coupled with the bus slot 110. The bus slot conversion module 100 is shown adjacent to the backplane 102, and shown as part of the bus slot conversion module 100 is the canister 114. Shown coupled to the canister 114 are the conversion portion 112 and the first and second peripherals 106, 108. Also shown is the conversion portion 112 coupled to the first and second peripherals 106, 108.

In several embodiments, the backplane 102 is part of a rack mounted computer system, e.g., a server farm system. The backplane 102 may be any industry standard backplane. In some embodiments, for example, the backplane 102 is compliant with a PCI Industrial Computer Manufacturers Group (PICMG) 2.16 standard. In these embodiments, as one of ordinary skill in the art recognizes, the bus slot 110 is a compact PCI slot and the backplane bus 104 is a PCI backplane bus. It should be recognized, however, that the bus slot 110 need not be a compact PCI bus slot and may be, for example, a full size PCI bus slot.

The conversion portion 112 according to several embodiments provides a mechanical and electrical conversion from the bus slot 110 to peripheral connectors utilized by the first and second peripheral devices 106, 108. In several embodiments, for example, the bus slot 110 is a compact PCI slot and the first and second peripherals 106, 108 have Single Connection Attachment (SCA) connectors. In these several embodiments, the conversion portion 112 has a compact PCI connector for coupling with the compact PCI slot on the backplane 104, and the conversion portion also has SCA slots for coupling with SCA connectors of the first and second peripherals 106, 108. Thus, the conversion portion 112 provides a mechanical transition from a compact PCI slot to an SCA slot. In addition, the conversion portion 112 provides electrical conversion and coupling to interconnect the peripheral slots with the bus slot 110 so the first and second peripherals may communicate with the backplane 102 over the bus slot 110.

The canister 114 according to several embodiments houses the first and second peripheral and provides mechanical support to the conversion portion 112. In some embodiments, for example, the canister 114 includes printed circuit boards that are coupled to a frame infrastructure to form a rectangular canister which surrounds the first and second peripherals 106, 108. According to several embodiments, the canister 114 is configured to be placed in a rack-mountable chassis, and to couple with the bus slot 110 on the backplane 102. In many embodiments, the canister 114 is configured so that the first and second peripherals 106, 108 are readily removable from the canister 114 while the canister remains in the rack mountable chassis.

The first and second peripherals 106, 108 may be any type of storage device, e.g., floppy drives, disk drives, compact disk drives, or digital video disk (DVD) drives. In practice, according to several embodiments, the backplane 102 is part of a computer system that is located within a rack mounted chassis, and the canister 114 in several embodiments is inserted in an available slot of the rack mounted chassis. The first and second peripherals 106, 108 are placed within the canister 114 and coupled by the conversion portion 112 to the bus slot 110. In this way, the first and second peripherals 106, 108 are communicatively coupled with the backplane 102, and hence, other components coupled with the backplane 102.

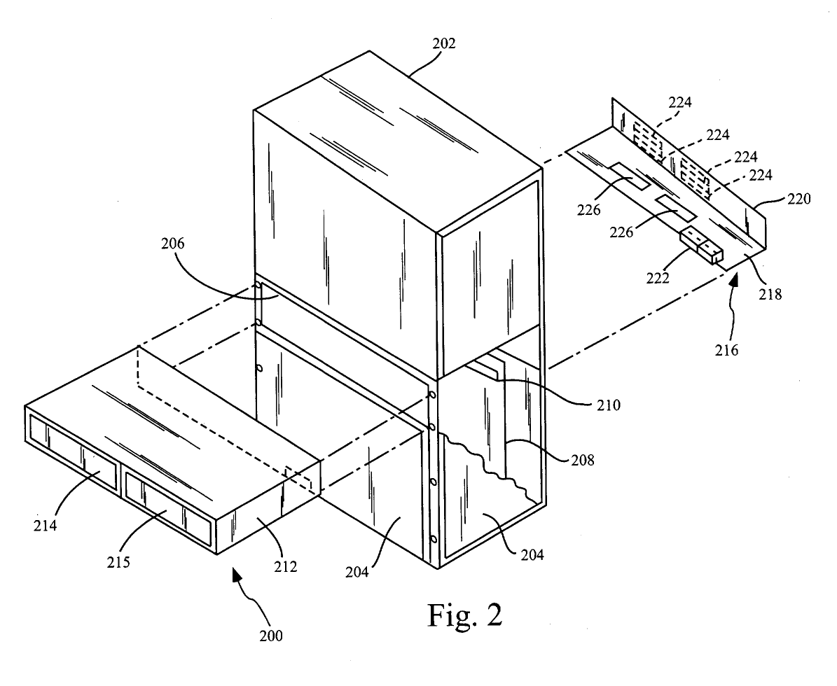

Referring next to FIG. 2, shown is a schematic view of one embodiment of the bus slot conversion module of FIG. 1. Shown are a bus slot conversion module 200, a rack 202, a chassis 204, an available chassis slot 206, a backplane 208, a bus slot 210, a canister 212, a first peripheral dock 214, a second peripheral dock 215, a rear transition module 216, a rear printed circuit board 218 (hereinafter referred to as a rear PCB board 218), a rear transition panel 220, a rear bus slot connector 222, rear horizontal peripheral slots 224 and rear vertical peripheral slots 226.

The chassis 204 is located within and coupled to a bottom portion of the rack 202. Within and coupled to the chassis 204 is the backplane 208, and within the chassis is the available chassis slot 206. Also shown adjacent to the chassis 204 and at a front side of the chassis 204 is the bus slot conversion module 200 that includes the canister 212. Within the canister 212 are the first and second peripheral docks 214, 215. The rear transition module 216 is shown outside the chassis 204 in position to be placed in the chassis 204 from a rear side of the chassis opposite to the bus slot conversion module 200.

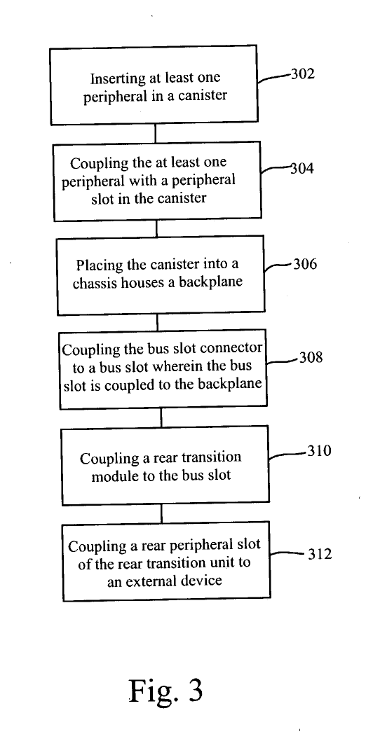

While referring to FIG. 2, simultaneous reference will be made to FIG. 3 which is a flow chart showing steps traversed by a user when implementing the bus slot conversion module 200.

The rear transition module 216 is shown with the rear PCB board 218 coupled the rear panel 220. Coupled with the rear PCB board 218 are the rear bus slot connector 222 and rear vertical peripheral slots 226. Coupled with the rear panel 220 are the rear horizontal slots 224.

As shown in FIG. 2, the rack 202 supports the chassis 204 that houses the backplane 208 and the bus slot conversion module 200 (when inserted in the chassis 204). The chassis 204, according to several embodiments, is mounted with the rack 202 and provides a convenient platform for housing and interconnecting components of, for example, a server system.

The available chassis slot 206 is an unoccupied portion of the chassis 204 which is available for several different types of components, e.g., switching modules, power modules, and in several embodiments, the bus slot conversion module 200.

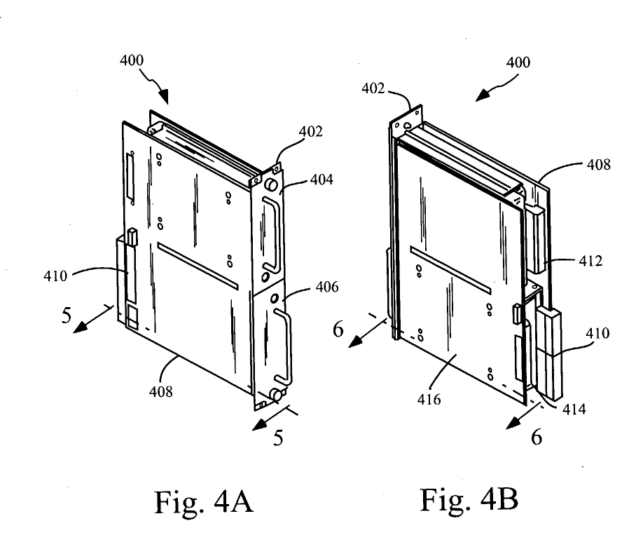

The bus slot conversion module 200 according to several embodiments is designed to detachably mount and to fit within the available chassis slot 206. As discussed further herein with reference to FIG. 4A, the bus slot conversion module 200 includes a bus slot connector, e.g., a compact PCI slot connector, that couples with the bus slot, e.g., a compact PCI slot, located on the backplane 208.

In the present embodiment, the canister 212 of the bus slot conversion module 200 forms the first and second peripheral docks 214, 215 that are configured to provide a platform for peripherals, e.g., media storage peripherals, to detachably mount within the canister 212. Within each of the first and second peripheral docks 214, 215 of the canister 212 is a peripheral slot (not shown), e.g., a SCSI slot, for coupling with a peripheral connector, e.g., a SCSI connector, of an inserted peripheral, e.g., the first peripheral 106 or the second peripheral 108.

In practice, at least one peripheral is inserted into one of the first or second peripheral docks 214, 215 in the canister 212 (Step 302 of FIG. 3). As the at least one peripheral is inserted into the canister 212 the at least one peripheral is coupled with a peripheral slot, e.g., a Single Connection Attachment (SCA) slot within the canister 212 (Step 304 of FIG. 3). Next, the bus slot conversion module 200 is inserted into the available chassis slot 206 and the bus slot connector, e.g., a compact PCI slot connector (not shown), couples with the bus slot, e.g., a compact PCI slot, located on the backplane 208 (Steps 306 and 308 of FIG. 3). In this way, the peripheral slots within the canister 212 become coupled with the bus slot 210. Thus, peripherals, e.g., SCSI peripherals, that are not compatible with the bus slot 210, e.g., a PCI slot, may communicate with the backplane 208, and hence, components coupled with the backplane 208.

It should be recognized that peripherals need not be inserted in the canister 212 prior to placing the bus slot conversion module 212 in the available chassis slot 206. In several embodiments, peripherals are hot swappable and may be inserted and removed after the bus slot conversion module 212 is within the chassis 204 and coupled with the backplane 208.

Advantageously, the bus slot conversion module 212 provides a very simple expansion of the backplane's I/O slots, and a conversion from a pin configuration of the bus slot 210, e.g., a compact PCI slot pin configuration to a pin configuration of a peripheral slot, e.g., a Single Connection Attachment (SCA) slot pin configuration, that couples with a peripheral within the canister 212. Specifically, there is no need to cut or otherwise modify the backplane 208; instead, the bus slot conversion module 200 is simply inserted into the available slot 206 of the chassis 204 until a bus slot connector of the bus slot conversion module 212 detachably couples with the bus slot 210 on the backplane 208. In this way, the bus slot conversion module 200 provides a universal transition from any industry standard backplane bus, e.g., PCI bus, to peripherals in the canister 212. Additionally, in several embodiments, the bus slot conversion module 200 is a modular building block. For example, several bus slot conversion modules 200 may be coupled with the backplane 208 and controlled as a redundant array of independent disks (RAID); thus, providing a very flexible data storage entity with enhanced performance and data integrity.

In some embodiments, the bus slot conversion module 200 is used in conjunction with the rear transition module 216. The rear transition module 216 according to several embodiments is designed to fit within a rear slot of the chassis 204 so a user may couple the rear transition module to a rear portion of the bus slot 210 (Step 310). The rear bus slot connector 222, e.g., a compact PCI connector, is configured to couple with a rear portion of the bus slot, e.g., a compact PCI slot. When the rear transition module 216 is completely inserted within a rear part of the chassis 204, the rear horizontal peripheral slots 224, e.g., Single Connection Attachment (SCA) slots, are exposed to an outside area of the chassis 204, i.e., the horizontal peripheral slots 224 are accessible from outside of the chassis 204 at the rear of the chassis 204. Thus, the rear transition module 216 provides a conversion from a bus slot of one type of pin configuration to multiple peripheral slots of a second type of pin configuration that are accessible from the rear of the chassis 204. A user may then simply couple one of the horizontal peripheral slots 224 to an external device (Step 312).

The rear vertical peripheral slots 216, however, provide access to the rear transition module 216 from within the chassis (when the rear transition module is inserted in the chassis.) Advantageously, the rear horizontal peripheral slots 224 of the rear transition module 216 allow interconnections to be made from the backplane 208, through the rear transition module 216 to a second chassis in another rack or to other peripherals. Thus, a user may optionally extend the backplane 208 so that the backplane 208 is connectable from a rear of the chassis 204.

Beneficially, the rear transition module 216 also allows the bus slot conversion module 200 to communicatively couple with other devices coupled to the backplane 208 when the bus slot conversion module 200 would not ordinarily be able to do so. For example, some backplanes do not have traces to each of the pins of an available bus slot, and thus, the available bus slot cannot operationally couple peripherals in the bus slot conversion module 200 to other components coupled with the some backplanes. The rear transition module 216, when coupled with the backplane 208 behind the bus slot conversion module 200, provides interconnects between the bus slot 210 (which is coupled to the bus slot conversion module 200) and the rear vertical peripheral slots 226, and the rear vertical peripheral slots 226 can be coupled to other components, e.g., a single board computer (SBC).

It should be recognized, however, that in several embodiments, the rear transition module 216 is not required and provides additional functionality to the bus slot conversion module 200 at a user's option.

Referring next to FIG. 4A, shown is a perspective view of one embodiment of the bus slot conversion modules of FIGS. 1 and 2. Shown is a bus slot conversion module 400, a front panel 402, a first peripheral face plate 404, a second peripheral face plate 406, a first printed circuit board 408 (hereinafter referred to as the first PCB board 408) and a bus slot connector 410.

The first PCB board 408 is coupled to the front panel 402 and the bus slot connector 410. The first and second peripheral face plates 404, 406 are arranged in tandem and coupled to the front panel 402.

The first and second peripheral face plates 404, 406 are each coupled to a respective first and second peripherals, e.g., the first and second peripheral 106, 108, that are obstructed from view in FIG. 4A. The first and second peripheral face plates 404, 406 function to both detachably couple the first and peripherals to the front panel 402 and provide a user interface, e.g., a handle, for a user to hold while, e.g., installing the first and second peripherals in the bus slot conversion module 400.

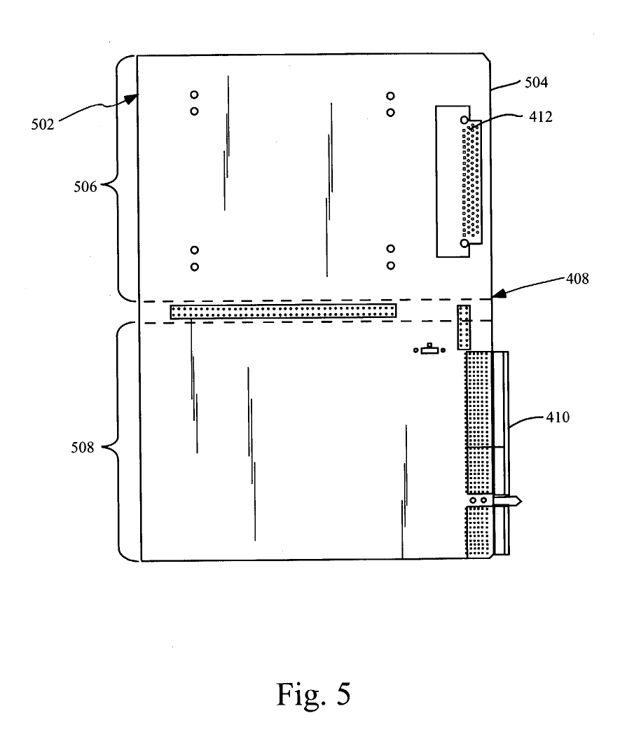

The first PCB board 408 according to several embodiments provides electrical interconnects from the bus slot connector 410 to a first peripheral slot and to other interconnects that couple with a second peripheral slot. As discussed further with reference to FIG. 5, in several embodiments, the electrical interconnects on the first PCB board 408 from the bus slot connector 410 to the first peripheral slot provide a conversion from a pin arrangement of the bus slot connector 410, e.g., a compact PCI connector pin arrangement, to a pin arrangement of the first peripheral slot, e.g., a SCA pin arrangement. Thus, in several embodiments, the first PCB board 408 is part of a conversion portion, e.g., the conversion portion 112, of the bus slot conversion module 400.

The bus slot connector 410 in several embodiments is a compact PCI connector that couples with a compact PCI slot on a computer backplane, e.g., the backplane 210.

In practice, as discussed with reference to FIG. 2, the bus slot conversion module 400 is inserted within a rack mountable chassis, e.g., the chassis 204, so that the bus slot connector 410 couples with a bus slot, e.g., bus slot 210, on a backplane, e.g., backplane 208.

Referring next to FIG. 4B, shown is another view of the bus slot conversion module 400 of FIG. 4A. Shown is the bus slot conversion module 400, including the front panel 402, the first PCB board 408, the bus slot connector 410, a first peripheral slot 412, a second peripheral slot 414, and a second printed circuit board 416 (herein after referred to as the second PCB board 416).

The second PCB board 416 is coupled with the second peripheral slot 414 and the front panel 402 and is arranged substantially parallel to the first PCB board 408. The first and second PCB boards 408, 416 are separated by a space that is maintained in part by the front panel 402. The space allows a first and second peripherals, e.g., the first and second peripherals 106, 108 to fit between the first and second PCB boards 408, 416. Coupled with the first PCB board 408 are the first peripheral slot 412 and the bus slot connector 410.

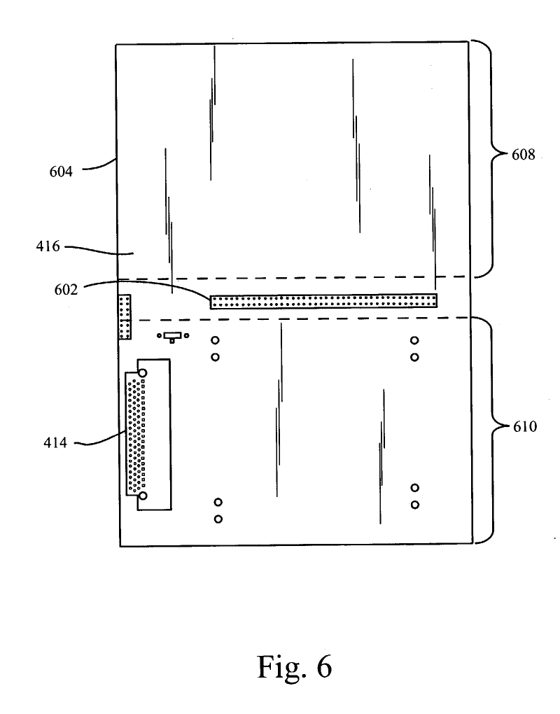

The second PCB board 416 provides electrical interconnects from pins of the second peripheral slot 414 to interconnects that, as discussed further with reference to FIGS. 6 and 14, lead to interconnects that span across the space between the first and second PCB boards 408, 416 to couple with the first PCB board 408. The interconnects that span the space between the first and second PCB boards 408, 416 couple with interconnects on the first PCB board 408 that couple with pins of the bus slot connector 410. Thus, in several embodiments, the second PCB board 416 and the first PCB board 408, along with interconnects that couple the first and second PCB boards 408, 416 are part of a conversion portion, e.g., conversion portion 112, of the bus slot conversion module 400 that converts a pin arrangement of the bus slot connector 410 so that it matches pin arrangements of the first and second peripheral slots 412, 414.

Additionally, the first and second PCB boards 408, 416 make up part of a canister, e.g., canister 212, of the bus slot conversion module 400. Specifically, in some embodiments, outside surfaces of the first and second PCB boards 408, 416 form respective outer surfaces of the bus slot conversion module 400 wherein peripherals are interposed between the first and second PCB boards 408, 416.

The first peripheral slot 412 and the second peripheral slot 414 in several embodiments are single connector attachment (SCA) slots for coupling with peripherals that have SCA connectors, e.g., the first and second peripherals 106, 108.

In other embodiments, the first peripheral slot 412 and the second peripheral slot 414 are integrated drive electronics (IDE) slots for coupling with IDE compatible peripherals.

In practice, according to several embodiments, a first and/or second peripheral, e.g., hard drives, CD ROM drives, floppy drives and/or DVD drives, are inserted in the bus slot conversion module 400 through the front panel 402. The first and second peripheral slots 412, 414 are situated at an opposite end of the front panel 402 to respectively couple with first and second peripherals when the first and second peripherals are completely inserted within the bus slot conversion module 400.

Referring next to FIG. 5, shown is a view taken along line A-A in FIG. 4A illustrating features of the first PCB board 408. Shown are the first PCB board 408, a front edge 502 of the first PCB board 408, a rear edge 504 of the first PCB board 408, a first peripheral portion 506 of the first PCB board 408, a second peripheral portion 508 of the first PCB board 408, the first peripheral slot 412, and the bus slot connector 410.

The first peripheral slot 412 is coupled to the first PCB board 408 near the rear edge 504 of the first PCB board 408 and within the first peripheral portion 506 of the first PCB board 408, and the bus slot connector 410 is coupled to the first PCB board 408 near the rear edge 504 of the first PCB board 408 within the second peripheral portion of the first PCB board 408.

The first PCB board 408 supports the first peripheral slot 412 and the bus slot connector 410, and also functions as part of a conversion portion of the bus slot conversion module 400, i.e., it provides electrical interconnects to couple pins of the first peripheral slot 412 and the bus slot connector 410. In several embodiments, for example, interconnects on the first PCB board 408 couple the first peripheral slot 412, e.g., a single connector attachment (SCA) slot, with appropriate pins of the bus slot connector 410, e.g., a compact PCI connector. One of ordinary skill in the art is able to connect corresponding pins of a single connector attachment (SCA) slot, an ordinary SCSI slot, or IDE slot with a compact PCI connector using PCB board interconnects; thus further detail of connections between the first peripheral slot 412 and the bus slot connector 410 are not provided.

In practice, a first peripheral, e.g., a floppy drive, disk drive, compact disk drive, or digital video disk (DVD) drive, is coupled with the first peripheral slot 412, and hence, coupled with the first the bus slot connector 410. Thus, when the bus slot conversion module 400 is inserted into an available chassis slot, e.g., available chassis slot 206, and the bus slot connector 410 is coupled with a bus slot, e.g., bus slot 210, on a backplane, e.g., backplane 208, the first peripheral is coupled with a backplane bus, e.g., backplane bus 104, and thus, to other components coupled with the backplane bus.

Referring next to FIG. 6, shown is a view taken along line B-B in FIG. 4B illustrating features of the second PCB board 416. Shown is the second PCB board 416, a transverse coupling 602, a rear edge 604 of the second PCB board 416, a second peripheral slot 414, a first peripheral portion 608, and a second peripheral portion 610.

The second PCB board 416 is shown generally sectioned into the first peripheral portion 608 and the second peripheral portion 610. The second peripheral slot 414 is shown coupled with the second PCB board 416 in the second peripheral portion 610 near the rear edge 604 of the second PCB board 416. The transverse coupling 602 is shown coupled to the second PCB board 416 in between the first peripheral portion 608 and the second peripheral portion 610.

The second PCB board 416 supports the second peripheral slot 414 and also functions as part of a conversion portion of the canister, i.e., it provides electrical interconnects to couple pins of the second peripheral slot 414 and the transverse coupling 602. In several embodiments, for example, interconnects on the second PCB board 416 couple the second peripheral slot 414, e.g., a single connector attachment (SCA) connector, with pins of the transverse coupling 602. The transverse coupling 602 is a collection of leads that electrically couple the first and second PCB boards 408, 416. Specifically, the transverse coupling 602 electrically connects with interconnects of the first PCB board 408 that couple with the bus slot connector 410.

One of ordinary skill in the art is able to connect corresponding pins of a single connector attachment SCA connector, an ordinary SCSI connector, or IDE connector with pins of the transverse coupling 602, and couple the pins of the transverse coupling 602 to appropriate interconnects on the first PCB board 408 that connect with the bus slot connector 410; thus further detail of connections between the second peripheral slot 414 and the bus slot connector 410 are not provided.

In practice, a second peripheral, e.g., a floppy drive, disk drive, compact disk drive, or digital video disk (DVD) drive, is coupled with the second peripheral slot 414, and hence, coupled with the bus slot connector 410. Thus, when the bus slot conversion module 400 is inserted into an available chassis slot, and the bus slot connector 410 is coupled with a bus slot, e.g., bus slot 210, on a backplane, e.g., backplane 208, the second peripheral is coupled with the backplane bus, e.g., backplane bus 104, and thus, to other components coupled with the back plane bus.

Referring next to FIG. 7, shown is a perspective view of the bus slot conversion module of FIG. 4B with the second PCB board 416 removed. Shown are the front panel 402, an upper frame bracket 702 (also referred to as a first frame bracket 702), a lower frame bracket 704 (also referred to as a lower frame bracket 704), a first peripheral 706, the first peripheral slot 412, a second peripheral 708, a second peripheral slot connector 710, and the bus slot connector 410.

The front panel 402 is coupled with the upper frame bracket 702 and the first peripheral 706 is detachably coupled with the upper frame bracket 702. The first peripheral 706 is coupled with the first peripheral slot 412 and the first peripheral slot 412 is coupled with the first PCB board 408. The second peripheral 708 is detachably coupled with the lower frame bracket 704 and the second peripheral slot connector 710 is coupled with the second peripheral 708. Also coupled with the first PCB board 408 is the bus slot connector 410.

The upper frame bracket 702 functions as part of a canister, e.g., canister 114, to support the first PCB board 408, to guide the first peripheral 706 into the bus slot conversion module 400 when the first peripheral 706 is inserted in the bus slot conversion module 700 and to support the first peripheral 706 while the first peripheral 706 is in the bus slot conversion module 400. In FIG. 7, the upper frame bracket 702 is partially obstructed from view by the first peripheral 706.

The lower frame bracket 704 also functions as part of a canister, e.g., canister 114, to provide support for the second peripheral 708 while the second peripheral 708 is in the bus slot conversion module 700, and to couple with, and help support, the second PCB board 416.

In practice, the first peripheral 706 is inserted into the bus slot conversion module through the front panel 402 along the upper frame bracket 702 until a first peripheral slot connector (not shown) of the first peripheral 706 couples with the first peripheral slot 412. Similarly, the second peripheral 708 is inserted into the bus slot conversion module 700 through the front panel 402 along the lower frame bracket 704 until the second peripheral slot connector 710 couples with the second peripheral slot 414.

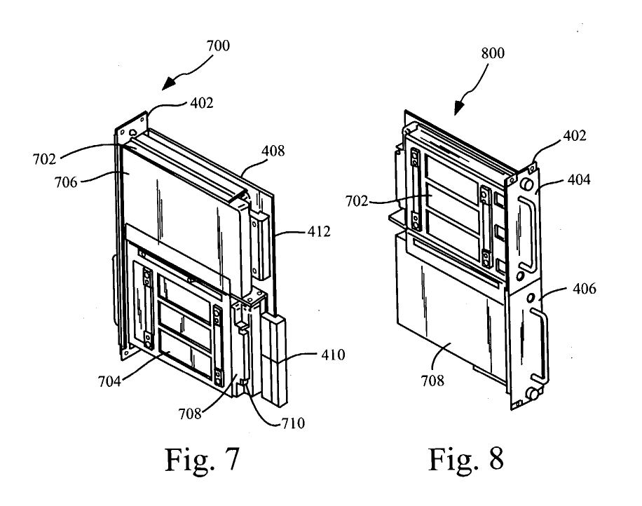

Referring next to FIG. 8, shown is a perspective view of the bus slot conversion module 400 of FIG. 4A with the first PCB board 408 removed. Shown is the upper frame bracket 702, the front panel 402, the first and second peripheral face plates 404, 406, and the second peripheral 708.

A face of the upper frame bracket 702 normally coupled with the first PCB board 408 is shown exposed and coupled with the front panel 402. The first peripheral face plate 404 and the second peripheral face plate 406 are shown in a tandem relation to each other and are both coupled with the front panel 402. The second peripheral 708 is coupled with the second peripheral face plate 406 and is shown extending through the front panel 402 to a rear portion of the bus slot conversion module 800.

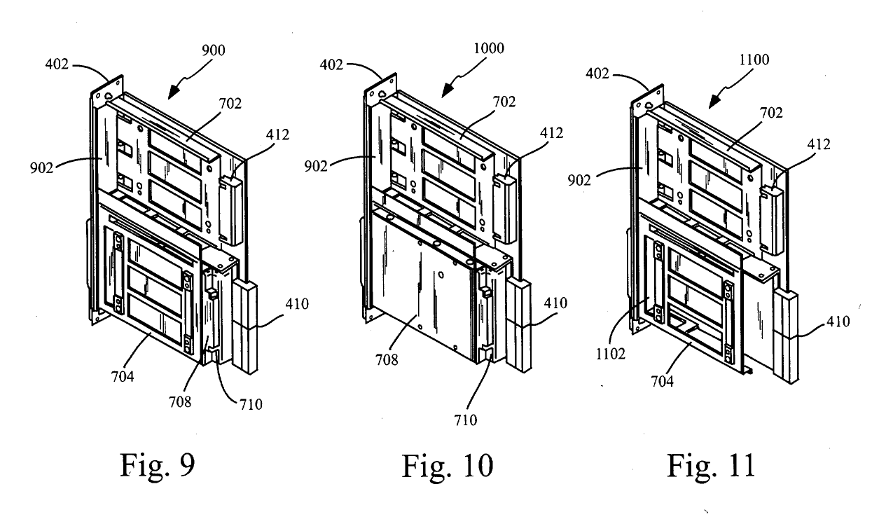

Referring next to FIG. 9, shown is a view of the bus slot conversion module 700 of FIG. 7 with the first peripheral 706 removed. Shown are the front panel 402, the upper frame bracket 702, the first peripheral slot 412, the lower frame bracket 704, the second peripheral 708, the second peripheral slot connector 710, the bus slot connector 410, and the front panel 402. Also shown is a first panel slot 900.

The components shown of the bus slot conversion module 900 of FIG. 9 are shown interconnected as in FIG. 7 except that the first peripheral 706 is shown removed; thus exposing the first panel slot 900 in the front panel 402 and an inside portion of the upper frame bracket 702.

In practice, the first panel slot 902 provides an opening through which the first peripheral 706 is inserted and guided by the upper frame bracket 702 until a first peripheral slot connector of the first peripheral 706 couples with the first peripheral slot 412. Thus, the first panel slot 902, the upper frame bracket 702 and the first peripheral slot 412 form a first peripheral dock, e.g., the first peripheral dock 214.

Referring next to FIG. 10, shown is a view of the bus slot conversion module 900 of FIG. 9 with the lower frame bracket 704 removed. Shown are the front panel 402, the upper frame bracket 702, the first peripheral slot 412, the second peripheral 708, the second peripheral slot connector 710, the bus slot connector 410, the front panel 402, and the first panel slot 902.

The components of the bus slot conversion module 1000 shown in FIG. 10 are shown interconnected as the bus slot conversion module 900 of FIG. 9 except that the lower frame bracket 704 is removed; thus exposing the second peripheral 708 to view. As shown, the second peripheral 708 is completely inserted within the bus slot conversion module 1000 and extends almost a full length of the bus slot conversion module 1000.

Referring next to FIG. 11, shown is a view of the bus slot conversion module 900 of FIG. 9 with the second peripheral 708 removed. Shown are the front panel 402, the upper frame bracket 702, the first peripheral slot 412, the bus slot connector 410, the front panel 402, the first panel slot 902, the lower frame bracket 704, and a second panel slot 1102.

The components shown in FIG. 11 are shown interconnected as in FIG. 9 except that the second peripheral 708 is removed; thus exposing the second panel slot 1102 to view in the front panel 402 through the lower frame bracket 704.

In practice, the second panel slot 1102 provides an opening through which the second peripheral 708 is inserted and guided by the lower frame bracket 704 until the second peripheral slot connector 710 couples with the second peripheral slot 414. Thus, the second panel slot 1102, the lower frame bracket 704 and the second peripheral slot 414 form a second peripheral dock, e.g., the second peripheral dock 215.

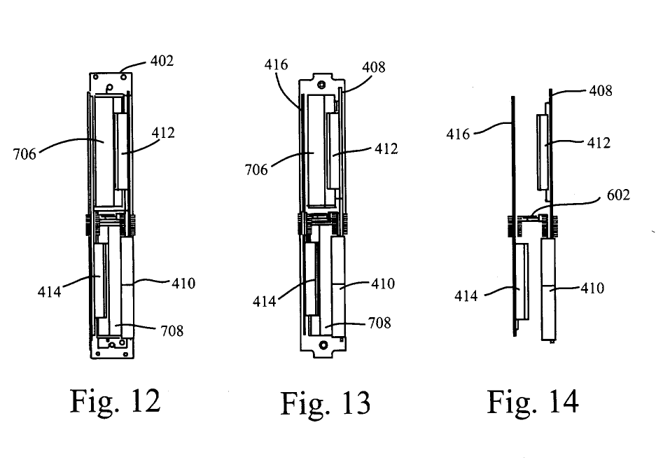

Referring next to FIG. 12, shown is a rear view of the bus slot conversion module of FIG. 4A. Shown are the first peripheral 706, the first peripheral slot 412, the second peripheral 708, the second peripheral slot 414, and the bus slot connector 410.

The first peripheral 706 is shown coupled with the first peripheral slot 412 at a rear end of the bus slot conversion module 400 (an end opposite the front panel 402), and the second peripheral 708 is shown coupled with the second peripheral slot 414 at the rear end of the bus slot conversion module 400. Also shown at the rear end of the bus slot conversion module is the bus slot connector 410.

Referring next to FIG. 13, shown is another rear view of the bus slot conversion module of FIG. 4A showing a relationship between the first and second peripherals 706, 708 and the first and second PCB boards 408, 416.

Shown are the first PCB board 408, the first peripheral 706, the second PCB board 416 and the second peripheral 708. The first and second PCB boards 408, 416 are each shown closely sandwiched between the first and second PCB boards 408, 416, however, the upper and lower frames 702, 704 separate the first and second peripherals 706, 708 respectively from the first and second PCB boards 408, 416.

Referring next to FIG. 14, shown is an end view of the first and second PCB boards 408, 416 and interconnections between them. Shown are the first PCB board 408, the first peripheral slot 412, the transverse coupling 602, the second PCB board 416, the second peripheral slot 414 and the bus slot connector 410.

The first peripheral slot 412 and the bust slot connector 410 are shown coupled with the first PCB board 408, and the second peripheral slot 414 is coupled with the second PCB board 416. The first and second PCB boards 408, 416 are shown coupled by the transverse coupling 602.

As discussed previously with reference to FIG. 6, the transverse coupling is a collection of leads that electrically couple the first and second PCB boards 408, 416. Specifically, interconnects on the second PCB board 416 (e.g., traces) that connect with the second peripheral slot 414 are coupled by the transverse coupling 602 to interconnects on the first PCB board 408 that connect with the bus slot connector 410.

In practice, the first and second PCB boards 408, 416 and the transverse coupling 602 function to convert the bus slot connector 410 to the first and second peripheral slots 412, 414. Thus, according to several embodiments, the first and second PCB boards 408, 416 and the transverse coupling 602 are part of a conversion portion of a canister, e.g., canister 212.

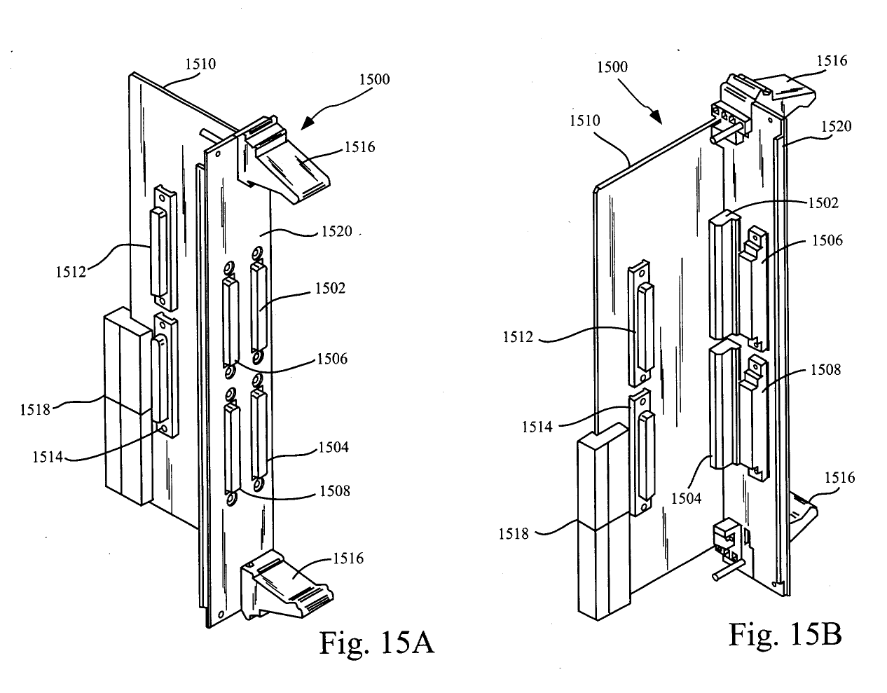

Referring next to FIG. 15A, shown is a rear transition module 1500 in accordance with one embodiment of the rear transition module of FIG. 2. Shown are the rear transition module 1500, a first, second, third and forth horizontal peripheral slots, 1502, 1504, 1506, 1508 a rear PCB board 1510, a first and second vertical peripheral slots, 1512, 1514 handles 1516, a rear bus slot connector 1518, and a rear transition panel 1520 The rear transition panel 1520 is coupled with the rear PCB board 1510 and the first, second, third and forth horizontal peripheral slots 1502, 1504, 1506, 1508. Coupled with the rear PCB board 1510 are the first and second vertical peripheral slots 1512, 1514 and the rear bus slot connector 1518.

The rear bus slot connector 1518 in several embodiments is a compact PCI connector that is designed to couple with a bus slot of a backplane, e.g., the rear bus slot 210 of the backplane 208.

In several embodiments, the rear PCB board 1510 provides electrical interconnects between the first and second vertical peripheral slots 1512, 1514 and the first and second horizontal peripheral slots 1502, 1504, but does not electrically interconnect with the third and forth horizontal peripheral slots 1506, 1508. In these embodiments, cables are used to couple the first vertical peripheral slot 1512 with the third horizontal peripheral slot 1506 and the second vertical peripheral slot 1514 with the forth horizontal peripheral slot 1508.

In operation, as discussed with reference to FIG. 2, the rear transition module 1500 is inserted into a rear portion of a chassis, e.g., the chassis 204, and coupled with a rear side of an available bus slot, e.g., bus slot 210, on a backplane, e.g., backplane 208. Once in the chassis, the rear transition module 1500, according to several embodiments, provides peripheral slots at a rear of the backplane. In the present embodiment, there are four horizontal peripheral slots, i.e., the first, second, third and forth horizontal peripheral slots 1502, 1504, 1506, 1508 that are accessible from a rear of a chassis.

Referring next to FIG. 15B, shown is an inside and perspective view of the rear transition module of FIG. 15A. Shown are the rear transition module 1500, the rear transition panel 1520, the first, second, third and forth horizontal peripheral slots 1502, 1504, 1506, 1508, the rear PCB board 1510, the first and second vertical peripheral slots 1512, 1514, the handles 1516, and the rear bus slot connector 1518.

The described components of FIG. 15B are coupled in the same manner, and interoperate in the same manner as the corresponding components of FIG. 15A. As shown in FIG. 15B, the first and second horizontal peripheral slots 1512, 1514 are coupled from an inside of the rear transition panel 1520 to the rear PCB board 1510; thus interconnects from the rear bus slot connector 1518 to the first and second horizontal peripheral slots 1502, 1504 are easily made with the rear PCB board 1510.

While the invention herein disclosed has been described by means of specific embodiments and applications thereof, numerous modifications and variations could be made thereto by those skilled in the art without departing from the scope of the invention set forth in the claims.

1. A bus slot conversion module comprising:
a canister comprising a first frame bracket and a front panel wherein the first frame bracket is coupled with the front panel wherein the first frame bracket is configured to support a first peripheral, wherein the front panel is configured to couple with a front side of a chassis; and
a conversion portion comprising a first PCB board wherein the first PCB board is coupled to the first frame bracket and a first peripheral slot, the first PCB board comprising traces that interconnect the first peripheral slot and a bus slot connector coupled with the first PCB board;
wherein the first peripheral slot is configured to couple with the first peripheral;
wherein the bus slot connector is configured to couple with a bus slot wherein the first peripheral slot comprises a different pin configuration than the bus slot; and
wherein the bus slot is coupled with a backplane, wherein the backplane is within the chassis.

2. The bus slot conversion module of claim 1 wherein the canister comprises a second frame bracket coupled with the front panel wherein the second frame bracket is configured to support a second peripheral;
wherein the conversion portion comprises a second PCB board coupled with the second frame bracket, wherein the second PCB board is coupled with a second peripheral slot configured to couple with the second peripheral;
wherein the first PCB board and the second PCB board comprise traces that interconnect the second peripheral slot and the bus slot connector.

3. The bus slot conversion module of claim 2 wherein the first PCB board and the second PCB board are substantially parallel and wherein the first and second frame brackets are interposed between the first and second PCB boards and configured to form a first and second peripheral docks.

4. The bus slot conversion module of claim 3 wherein the first PCB board and the second PCB board are interconnected by a transverse coupling wherein the second peripheral is interconnected with the bus slot connector via the transverse coupling.

5. The bus slot conversion module of claim 1 wherein the at least one peripheral is a peripheral selected from the group consisting of a floppy drive, a disk drive, a compact disk drive, and a digital video disk (DVD) drive.

6. The bus slot conversion module of claim 1 or wherein the first peripheral slot is a small computer system interface (SCSI) slot.

7. The bus slot conversion module of claim 6 wherein the small computer interface (SCSI) slot is a Single Connection Attachment (SCA) slot.

8. The bus slot conversion module of claim 1 wherein the bus slot connector is a peripheral component interconnect (PCI) slot connector.

9. The bus slot conversion module of claim 8 wherein the peripheral component interconnect (PCI) slot connector is a compact peripheral component interconnect slot connector.

10. The bus slot conversion module of claim 1 wherein the peripheral slot is an integrated drive electronics (IDE) interface slot.

11. A method for using peripherals with an incompatible bus slot comprising:
inserting a first peripheral in a first peripheral dock of a canister wherein the first peripheral dock comprises a first frame bracket wherein the first peripheral is guided by the frame bracket and a front panel wherein the frame bracket is coupled with the front panel;
coupling the first peripheral with a first peripheral slot coupled to a first PCB board wherein the first PCB board is coupled to the first frame bracket, wherein a bus slot connector is coupled to the PCB board wherein the first PCB board interconnects the first peripheral slot with the bus slot connector;
placing the canister into a chassis wherein the chassis houses a backplane; and
coupling the bus slot connector with a bus slot wherein the bus slot is coupled to the backplane;
wherein the first peripheral slot comprises a different pin configuration than the bus slot.

12. The method of claim 11 further comprising the steps of:
inserting a second peripheral in a second peripheral dock of the canister wherein the second peripheral dock comprises a second frame bracket wherein the second peripheral is guided by the second frame bracket and the front panel wherein the second frame bracket is coupled with the front panel; and
coupling the second peripheral with a second peripheral slot coupled to a second PCB board wherein the second frame bracket is coupled with the second PCB board wherein the second peripheral slot is interconnected with the bus slot connector via the first PCB board.

13. The method of claim 11 further comprising the steps of:
coupling a rear transition module to the bus slot wherein the rear transition unit comprises a rear peripheral slot; and
coupling the rear peripheral slot to a device wherein the device is external to chassis.

14. The method of claim 11 wherein the step of inserting the first peripheral in the first peripheral dock comprises inserting the first peripheral in the first peripheral dock wherein the first peripheral is a peripheral selected from the group consisting of a floppy drive, a disk drive, a compact disk drive, and a digital video disk (DVD) drive.

15. The method of claim 11 wherein the step of coupling the first peripheral with the first peripheral slot comprises coupling the first peripheral with a first peripheral slot wherein the first peripheral slot is a Single Connection Attachment (SCA) slot.

16. The method of claim 115 wherein the step of coupling the bus slot connector with the bus slot comprises coupling the bus slot connector with the bus slot wherein the bus slot is a compact peripheral component interconnect slot connector.

17. The method of claim 11 wherein the step of coupling the first peripheral with the first peripheral slot comprises coupling the first peripheral with a first peripheral slot wherein the first peripheral slot is an integrated drive electronics (IDE) interface slot.

18. A bus slot conversion module comprising:
means for housing at least one peripheral wherein the at least one peripheral is selected from the group consisting of a floppy drive, a disk drive, a compact disk drive, and a digital video disk (DVD) drive wherein the means for housing is configured to detachably couple with a slot of a chassis wherein the means for housing houses a peripheral slot that is adapted to receive the at least one peripheral; and
means for converting the peripheral slot to a bus slot wherein the peripheral slot is selected from the group consisting of a Single Connection Attachment (SCA) slot, and an integrated drive electronics (IDE) interface slot and the bus slot is a compact peripheral component interconnect slot connector;
means for coupling the means for converting to the bus slot.
